(19) United States
(12) Patent Application Publication
(10) Pub. No.: US 2018/0162156 A1
(43) Pub. Date: Jun. 14, 2018

(54) STIRRER FOR A VISCOUS LIQUID

(71) Applicant: Fast & Fluid Management B.V., Sassenheim (NL)

(72) Inventors: Johannes Hermanus Nicolaas Post, Sassenheim (NL); Mark Johannes Baak, Lisse (NL)

(73) Assignee: Fast & Fluid Management B.V., Sassenheim (NL)

(21) Appl. No.: 15/836,255

(22) Filed: Dec. 8, 2017

(30) Foreign Application Priority Data
Dec. 11, 2016 (EP) 16203328.6

(51) Int. Cl. B44D 3/08; B01F 7/00; B01F 7/20

(52) U.S. Cl. CPC B44D 3/08; B01F 7/20; B01F 7/00308; B01F 7/00191

(57) ABSTRACT

A container (1) for a viscous liquid, in particular a colorant for paint, may comprise a stirrer (2) having a rotatable shaft (3) and a plurality of paddles (4) connected to the shaft (3). At least one of the paddles (4) and/or the connections (5) between the paddles (4) and the shaft (4) is flexible.

### RELATED DOCUMENTS

This application claims the benefit of priority to European patent application Serial No. 16203328.6 filed Dec. 11, 2016, and entitled “STIRRER FOR A VISCOUS LIQUID.” The entirety of the aforementioned application is incorporated herein by reference.

### TECHNICAL FIELD

The invention relates to a container for a viscous liquid, in particular a colorant for paint, comprising a stirrer having a rotatable shaft, e.g. a single or composite shaft, extending through the center of the container and a plurality of paddles connected to the shaft.

### BACKGROUND

Brownian motion of particles suspended in liquids is not sufficient to overcome gravitational forces and such particles tend to settle out of the liquid and agglomerate. The paint industry has struggled with this problem for more than a hundred years. In order for a pigmented colorant to be successfully applied using colorant dispensers the suspension must be agitated, typically stirred.

EP 2 198 950 relates to an apparatus (denoted by numeral 1 in the Figures of that publication) for dispensing a plurality of fluids, comprising a support, such as a turntable (2) or a linear table, a plurality of containers (4) for holding a fluid mounted on the support (2), pumps (3) connected to respective containers (4), a common actuator (31) for sequentially operating the pumps (3), stirring elements mounted rotatably inside and extending from the containers (4), and a drive mechanism (21) for rotating the stirring elements.

WO 2008/110606 relates to a canister assembly comprising an annular outer shell (21) with an outer cylindrical wall connected to a bottom which, in turn, is connected to an inner cylindrical wall that serves as a standpipe. The bottom includes an outlet (29) connected to a pump. A hollow agitator shaft (21) slides over the inner standpipe and includes a plurality of outwardly extending blades (32) for stirring or “agitating” the fluid.

EP 1 908 510 relates to a device for mixing fluids, particularly paints and varnishes. The Figures of this publication shows a storage tank containing a stirring element. GB 1,004,721, EP 298 806 and KR 10-2016-0077346 also disclose stirring devices.

Stirrers are used in many forms and shapes. To achieve sufficient homogenization, turbulence is often created by increasing the rotational speed up to 3000 rpm (revolutions per minute). In applications involving liquids having a relatively high viscosity, stirrers are usually rotated relatively slowly, e.g. at rotational speeds in a range from 5 to 200 rpm. Such stirrers apply low shear to the liquids. Point of sale colorant systems, for example, are often equipped with stirrers running at a speed in a range from 20 to 40 rpm.

Colorants are typically viscous liquids with a complex structure to reduce pigment settlement during prolonged storage, i.e. colorants are frequently stored in containers in multi-container dispensers for longer periods, e.g. months, before depletion and refill. Further, to meet the requirements of current legislations, present day colorants contain reduced amounts of additives, such as agents for stabilization.

In consequence, colorants are more sensitive to degradation due to aging and applied shear.

This results often in an increase of the viscosity of the liquid to very high values in the range of 20-100 Pa·s or more. It was found that stirring such high viscosity liquids can result in an overload on the stirrer and/or the mechanism driving the stirrer. Also, extreme shear forces were found to accelerate degradation of the colorants.

It is desired to provide an improved stirrer for homogenizing viscous liquid, in particular colorants for paint, in a container.

### SUMMARY

To this end, the stirrer may be characterized in that at least one, preferably at least some or all of the paddles and/or the connections between the paddles and the shaft are flexible.

In an implementation, at least one, or at least some or all of the paddles and/or the connections between the paddles and the shaft may be configured to elastically flex and/or twist over at least 20 degrees, preferably at least 30 degrees.

In another implementation, the connection between at least one, or at least some or all of the paddles and the shaft has a torsional stiffness of less than 1,5 Nm/rad, preferably a torsional stiffness in a range from 0,1 to 1,0 Nm/rad, e.g. averaged over 1/8 π rad.

In another implementation, the stirrer may be configured such that the power taken up by the stirrer, in practice the power taken up by the electric motor driving the stirrer, rotating at 40 rpm in a liquid having a viscosity of 40 Pa·s is less than 100%, less than 50%, less than 40% higher than the power taken up by the (same) stirrer rotating at 40 rpm in a liquid having a viscosity of 10 Pa·s. As a matter of course, this experiment may be carried out ceteris paribus, i.e. under otherwise equal conditions. A reliable comparison can be achieved in a (circle)cylindrical container having an inner diameter that is 1 cm larger than the effective outer diameter of the stirrer, leaving a circumferential clearance of 0,5 cm.

In one implementation, flexing and/or twisting of the paddles will increase considerably with increasing viscosity of the liquid. In consequence, the load on the stirrer and the load exerted by the stirrer on the viscous liquid no longer increases proportionally with an increase of the viscosity of the viscous liquid but, instead, increases significantly less, and, as a result, the risk of failure of the stirrer or the mechanism driving the stirrer is reduced and/or the shear forces exerted on the colorant are reduced, extending the ‘container life’ of the liquid, such as a colorant.

In an implementation, at least some, or all of the paddles are at an inclination in a range from 30 to 60 degrees relative to the shaft, which during operation may be typically positioned vertically.

To improve circulation within the container, in an implementation, at least some, or all of the paddles may be connected to the shaft by means of arms, in particular rods. Thus, the paddles generate displacement of the liquid upwards or downwards (depending on the orientation of the paddles and the direction of rotation) and the liquid circulates (downwards or upwards, respectively) in the opposite direction. In an implementation, the thickness of the arms in the axial direction of the shaft is 30% or less, preferably 20% or less of the height of the in the axial direction of the shaft.

In another implementation, the arms connect asymmetrically to the paddles, e.g. either to the lower halves or the upper halves of the paddles. Asymmetric connection facilitates achieving sufficient lever and thus flexing of the paddles.

In an implementation, which is also efficacious in stirrers wherein the paddles are rigid relative to the shaft, at least one or some or all of the connections, e.g. arms, between the shaft and the paddles extend at an inclination, preferably in a range from 10 to 60 degrees, or in a range from 15 to 50 degrees relative to a plane perpendicular to the (centerline of the) shaft.

When the arms extend at an inclination, the mixing of air into the liquid at the surface of the liquid may be reduced or even prevented and/or liquid on the arms flows back to main body of liquid quicker.

In an implementation, the stirrer is made of a synthetic material, a thermoplastic polymer, such as POM, polyamide, polyester or a polyolefin, e.g. PE or PP.

In another implementation, the stirrer may comprise a series of paddles or sets of paddles—with each of the paddles in a set being located at the same or substantially the same axial position of the shaft but at a different radius—arranged along the length of the shaft such that the upper rims of the paddles may overlap, seen in the axial direction, with the lower rims of the paddle or set of paddles directly above it.

To urge or scrape sediments upwards, in an implementation, the lowermost paddle or set of paddles may extend to the bottom of the container, preferably leaving a clearance of less than 5, preferably less than 3 mm.

In another implementation, the container may have a circular cross-section, may be oblong, may have a height of less than 100 centimeters, may have a diameter smaller than 45 centimeters and/or extends vertically, at least when it contains the liquid.

An implementation may further relate to a stirrer for a viscous liquid, in particular a colorant for paint, having a rotatable shaft, e.g. a single shaft extending through the center of the container, and a plurality of paddles connected to the shaft. At least one, or at least some or all of the paddles and/or the connections between the paddles and the shaft may be flexible.

In an implementation, at least one, or at least some or all of the paddles and/or the connections between the paddles and the shaft are configured to elastically flex and/or twist over at least 20 degrees, preferably at least 30 degrees.

In a further implementation, the connection between at least one, or at least some or all of the paddles and the shaft has a torsional stiffness of less than 1,5 Nm/rad, preferably a torsional stiffness in a range from 0,1 to 1,0 Nm/rad.

In other implementations, the stirrer may have one or more of the features discussed above.

An implementation may further relate to an apparatus for dispensing a plurality of liquids, in particular colorants for paint, comprising a plurality of containers as described above.

Within the framework of the present invention the term “liquid” is defined as any flowable material that comprises a liquid phase and thus includes suspensions and emulsions. Colorants often contain high density pigments or particles suspended in (instable) liquid binder/solvent solutions.

### BRIEF DESCRIPTION OF THE DRAWINGS

The disclosed container and stirrer will be further explained with reference to the accompanying drawings in which a presently preferred embodiment of the invention is shown schematically. Details, that are not necessary for understanding the present invention, may have been omitted.

FIG. 1 is a perspective view of a container comprising a stirrer in accordance with the present invention.

FIG. 2 is a front view of the stirrer shown in FIG. 1.

FIG. 3 is a top view of the stirrer shown in FIG. 1.

### DETAILED DESCRIPTION

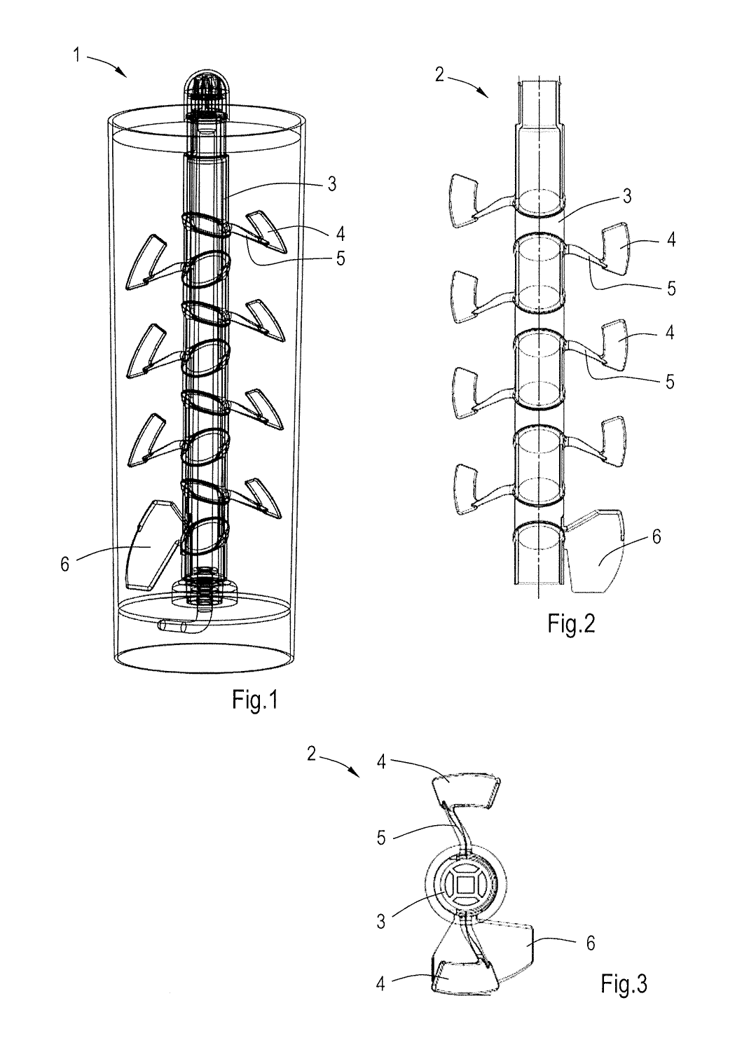

FIG. 1 shows an example of a container 1 for storing a liquid, such as colorants for paint, but also hair dyes, shampoos, foundations, and the like. It can be used in an apparatus, comprising a plurality, e.g. twelve, sixteen or twenty of such containers, for dispensing numerous recipes and formulas and located e.g. at a retailer of e.g. decorative paints.

The container 1 is provided with or coupled to a metering pump and a valve (not shown). Further information regarding suitable dispensing apparatuses and procedures for driving the various components, are disclosed in, for instance, European patent applications EP 800 858, EP 1 492 970, EP 1 688 652, and EP 2 198 950.

As shown in the Figures, the present container 1 has a circular cross-section and comprises a stirrer 2 having a rotatable shaft 3 extending through the center of the container. A plurality of paddles 4 are connected to the shaft 3 via relative thin arms 5, which extend at an inclination, e.g. 30 degrees and in downward direction, from the shaft to near the lower rim of each of the paddles. The arms 5 provide a substantial distance between the shaft and the paddles 4 and hold the paddles an angle of e.g. 45 degrees. In this example, the shaft, arms, and paddles form an integral whole and were manufactured by injection moulding a thermoplastic polymer, i.c. polyoxymethylene (POM). The combination of shape and material yielded torsional stiffness of the paddles of 0,6 Nm/rad. The paddles allowed elastical twisting over an angle of 45 degrees.

In top view, the outermost edge of the paddles is curved, having a radius 0,5 cm smaller that the inner radius of the container. The lowermost paddle extends to the bottom of the container, leaving a clearance of 1 mm.

During stirring cycles, performed e.g. one or more times per day, for a duration of from three to twenty minutes per cycle, and at a rotational speed of the stirrer in a range from 20 to 40 rpm, depending on the liquid in the container and on environmental conditions, such as temperature, the paddles generate displacement of the liquid upwards or downwards (depending on the orientation of the paddles and the direction of rotation) and the liquid circulates (downwards or upwards, respectively) in the opposite direction between the shaft and the paddles. Initially, the paddles will flex only slightly, but when the liquid ages and the viscosity of the liquid increases, the paddles will flex more, in extreme instances eventually to an almost horizontal position. Thus, the efficiency of the stirrer is reduced with increasing viscosity and, as a result, the risk of failure of the stirrer or the mechanism driving the stirrer is reduced and/or the shear forces exerted on the colorant are reduced, extending the ‘container life’ of the colorant.

As a matter of course, the invention is not restricted to the above-disclosed embodiment and can be varied in numerous ways within the scope of the claims

What is claimed is:

1. Container (1) for a viscous liquid, in particular a colorant for paint, comprising a stirrer (2) having a rotatable shaft (3) and a plurality of paddles (4) connected to the shaft (3), characterized in that at least one of the paddles (4) and/or the connections (5) between the paddles (4) and the shaft (4) is flexible.

2. Container (1) according to claim 1, wherein at least one of the paddles (4) and/or the connections (5) between the paddles (4) and the shaft (3) are configured to elastically flex and/or twist over at least 20 degrees, preferably at least 30 degrees.

3. Container (1) according to claim 1, wherein the connection (5) between at least one of the paddles (4) and the shaft (3) has a torsional stiffness of less than 1,5 Nm/rad, preferably a torsional stiffness in a range from 0,1 to 1,0 Nm/rad.

4. Container (1) according to claim 1, wherein the power taken up by the stirrer (2) rotating at 40 rpm in a liquid having a viscosity of 40 Pa·s is less than 100%, preferably less than 50%, preferably less than 40% higher than the power taken up by the stirrer (2) rotating at 40 rpm in a liquid having a viscosity of 10 Pa·s.

5. Container (1) according to claim 1, wherein at least some of the paddles (4) are at an inclination in a range from 30 to 60 degrees relative to the shaft (3).

6. Container (1) according to claim 1, wherein at least some of the paddles (4) are connected to the shaft (3) by means of arms (5).

7. Container (1) according to claim 6, wherein the arms (5) connect asymmetrically to the paddles (4).

8. Container (1) according to claim 6, wherein at least one preferably some or all of the connections (5) between the shaft (3) and the paddles (4) extend at an inclination, preferably in a range from 10 to 60 degrees, more preferably in a range from 15 to 50 degrees relative to a plane perpendicular to the shaft (3).

9. Container (1) according to claim 1, wherein the stirrer (2) is made of a synthetic material, preferably a thermoplastic polymer.

10. Container (1) according to claim 1, comprising a series of paddles (4) or sets of paddles (4) arranged along the length of the shaft (3).

11. Container (1) according to claim 1, wherein the lowermost paddle (4) or paddles (4) extends to the bottom of the container (1).

12. Container (1) according to claim 1, wherein the container (1) has a circular cross-section, is oblong, has a height of less than 100 centimeters, has a diameter smaller than 45 centimeters and/or extends vertically, at least when it contains the liquid.

13. Stirrer (2) for a viscous liquid, in particular a colorant for paint, having a central shaft (3) and a plurality of paddles (4) connected to the shaft (3), characterized in that at least one of the paddles (4) and/or the connections (5) between the paddles (5) and the shaft (3) are flexible.

14. Stirrer (2) according to claim 13, wherein at least one of the paddles (4) and/or the connections (5) between the paddles (4) and the shaft (3) are configured to elastically flex and/or twist over at least 20 degrees, preferably at least 30 degrees.

15. Stirrer (2) according to claim 13, wherein the connection (5) between at least one of the paddles (4) and the shaft (3) has a torsional stiffness of less than 1,5 Nm/rad, preferably a torsional stiffness in a range from 0,1 to 1,0 Nm/rad.
